(19) United States
(12) Patent Application Publication
(10) Pub. No.: US 2026/0254533 A1
(43) Pub. Date: Aug. 27, 2026

(54) COMMUNICATION USING LIGHT FIDELITY COMMUNICATION SIGNALS

(71) Applicant: International Business Machines Corporation, Armonk, NY (US)

(72) Inventors: Guang Han Sui, Beijing (CN); Peng Hui Jiang, Beijing (CN); Su Liu, Austin, TX (US); Jun Su, Beijing (CN)

(21) Appl. No.: 19/060,644

(22) Filed: Feb. 22, 2025

(51) Int. Cl. H04B 10/116; H04W 12/65

(52) U.S. Cl. CPC H04B 10/116; H04W 12/65

(57) ABSTRACT

Communication using light fidelity (LiFi) communication signals includes receiving LiFi communication signals from a light source. The LiFi communication signals are associated with a set of spectrum characteristics indicative of a set of chemical compounds. The set of chemical compounds is associated with the light source. The set of spectrum characteristics of the LiFi communication signals is analyzed. The set of spectrum characteristics of the LiFi communication signals is compared with a specified set of spectrum characteristics based on the analyzing of the set of spectrum characteristics. The LiFi communication signals are decoded based on the comparing. This enhances the security of data transmitted using the LiFi communication signals.

### BACKGROUND

The disclosure relates generally to the field of communication, more particularly, to wireless communication.

Light Fidelity (LiFi) is a wireless communication technology that uses light as communication signals to transmit data between devices. LiFi communication technology involves using light emitting from light-emitting diodes (LEDs) as a means of high-speed communication. LiFi is based on the ability of solid-state lighting systems to create a binary code of ones (1s) and zeros(0s) with light flickering. Specifically, when data is to be transmitted, the brightness of the LEDs oscillates at high speeds, typically in the order of millions of flickers per second. These oscillations or flickers represent binary codes of 1s and 0s (for example, if the LED is switched ON, a digital ‘1’ is transmitted, and if the LED is switched OFF, a digital ‘0’ is transmitted), and the high order of flickering results in high speeds of communication of the order of gigabits per second. At the receiving end, a photosensitive detector is used to capture the light signals. This data received at the detector is then converted into electronic signals.

LiFi communication technology is considered secure, as light cannot penetrate walls, reducing the risk of unauthorized access to the data outside a confined space. Even though LiFi offers better security than existing technologies such as wireless fidelity (Wi-Fi), there are certain risks associated with the security of data while using LiFi communication signals for communication.

### SUMMARY

In various embodiments of the disclosure, a computer-implemented method for communication using light fidelity (LiFi) communication signals is provided. The computer-implemented method includes receiving, by a computer, one or more LiFi communication signals associated with a set of spectrum characteristics. The set of spectrum characteristics is indicative of a set of chemical compounds associated with a light source. The one or more LiFi communication signals are received from the light source associated with a first electronic device. The computer-implemented method further includes analyzing, by the computer, the set of spectrum characteristics of the one or more LiFi communication signals. The computer-implemented method further includes comparing, by the computer, the set of spectrum characteristics of the one or more LiFi communication signals with a specified set of spectrum characteristics based on the analyzing of the set of spectrum characteristics. The computer-implemented method further includes decoding, by the computer, the one or more LiFi communication signals based on the comparing.

In various embodiments of the disclosure, a computer system for communication using LiFi communication signals is provided. The computer system includes a processor set, one or more computer-readable storage media, and program instructions stored on the one or more computer-readable storage media. The program instructions are executable by the processor set to cause the processor set to receive one or more LiFi communication signals associated with a set of spectrum characteristics. The set of spectrum characteristics is indicative of a set of chemical compounds associated with a light source. The one or more LiFi communication signals are received from the light source associated with a first electronic device. The program instructions further cause the processor set to compare the set of spectrum characteristics of the one or more LiFi communication signals with a specified set of spectrum characteristics. The program instructions further cause the processor set to calculate a difference value between the set of spectrum characteristics of the one or more LiFi communication signals and the specified set of spectrum characteristics based on the comparison of the set of spectrum characteristics of the one or more LiFi communication signals with the specified set of spectrum characteristics. The program instructions further cause the processor set to compare the calculated difference value with a threshold difference value. The program instructions further cause the processor set to decode the one or more LiFi communication signals based on the comparison of the calculated difference value with the threshold difference value.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for communication using light fidelity (LiFi) signal communication, in accordance with various embodiments of the disclosure;

FIG. 2 is a diagram that illustrates an environment for communication using LiFi signal communication, in accordance with various embodiments of the disclosure;

FIG. 3A is a diagram that illustrates exemplary operations at a sender side for communication using LiFi signal communication, in accordance with various embodiments of the disclosure;

FIG. 3B is a diagram that illustrates exemplary operations at a receiver side for communication using LiFi signal communication, in accordance with various embodiments of the disclosure;

FIG. 4 is a diagram that illustrates an exemplary set of resultant spectrums of LiFi communication signals in the form of visible light after passing through structures including different chemical compounds, in accordance with various embodiments of the disclosure;

FIG. 5 is a diagram that illustrates an exemplary set of components of an electronic device, in accordance with various embodiments of the disclosure;

FIG. 6 is a diagram that illustrates a first flowchart of a method for communication using LiFi communication signals, in accordance with various embodiments of the disclosure; and

FIG. 7 is a diagram that illustrates a second flowchart of a method for communication using LiFi communication signals, in accordance with various embodiments of the disclosure.

### DETAILED DESCRIPTION

Light emitting diodes (LEDs) can switch on and off at a pace of less than one microsecond. Also, data can be transmitted using binary coding where a ‘1’ may be considered an “on” state, and a ‘0’ may be considered an “off” state. A digital “1” is transmitted when the LED is turned on, and a digital “0” is transmitted when the LED is turned off. The data can be encoded in the form of light emitted by LEDs by forming various combinations of 1s and 0s by altering the pace at which the LEDs turn on and off. Additionally, there are no interferences in the visible light spectrum as there are in the radio frequencies. This results in efficient data transmission using LED lights.

Visible light communication (VLC) is a method for wireless communication of data for high-speed transmission of data using visible light spectrum range, that is, approx. 400 – 780 terahertz (THz) frequency. In the VLC, the intensity of light produced by a light source (such as, but not limited to, a light emitting diode) is modulated for transmitting data that is to be communication from a device/module at sender side to a device/module at receiver side. The light signal carrying the data (that is to be communication from sender side to receiver side) is received by a detector (such as, but not limited to, a photodiode device) at the receiving side. The data received by the detector is then converted into human readable form for presenting to the users. Light fidelity (LiFi) is a kind of VLC technology that uses light as a medium for high-speed communication similar to existing wireless communication technologies such as wireless fidelity (Wi-Fi), etc. but mitigating the risks associated with such existing technologies. LiFi is particularly suitable for areas with high density wireless coverage and that are geographically confined. Further, LiFi is also particularly useful in areas where electromagnetic interference issues are significant. Advantages of transmitting data using LiFi include, but are not limited to, better bandwidth than existing technologies, improved efficiency than existing technologies, better connectivity and security than existing wireless communication technologies such as Wi-Fi. Notably, LiFi has can achieve high data rates of even greater than 1 giga bits per second (Gbps), at least under certain desired conditions.

A basic LiFi system may include components such as a transmission source including a light emitting diode (LED) for sending the light signals, and a receiver including a photodetector (such as, but not limited to, a silicon photodiode) preferably with decent response to visible light for receiving the light signals. The transmission source may further include multiple components such as, but not limited to, a bulb assembly including the LED bulb, a power amplifier (PA) circuit, and an electronic circuit assembly. The electronic circuit assembly controls the inputs and outputs of the LED bulb and houses microprocessors, controllers, and integrated circuits to perform various functions. The bulb assembly may include the LED bulb embedded in a dielectric material. The bulb assembly acts at least as an electric field concentrator that focuses the energy into the bulb. The PA circuit generates a radio frequency (RF) signal and directs the same into the electric field of the bulb. This helps the contents of the LED bulb to vaporize into plasma state at the bulb’s center by concentrating the energy in the electric field of the LED bulb, which in turn produces high intensity visible light. The components may be enclosed in a housing. This housing may be made of any suitable material such as aluminum.

Overall, in the LiFi communication process, a light beam from an LED bulb is used to transmit data to a receiving device throughout the communication process. This LED bulb may be connected to a router (also referred to as an access point) that is connected to the internet network. The network transmits the data as an electrical signal to the LiFi transmitter, which converts the same into the form of light signals. The LiFi transmitter transmits data to the LiFi receiver that is situated within the light beam’s coverage area. On the receiver end, there may be a detector device such as a photodiode responsible that may capture the light signals and convert the captured light signals into electrical signals. The photodiode is connected to a processor that receives the electrical signals from the photodiode, and further processes the electrical signals to translate the electrical signals into a form for presentation that is understandable by the end user. Specifically, the process of LiFi communication includes, the LiFi transmitter receives the information from a device locally or via a network, the LiFi transmitter processes the information to transmit the information in the form of LiFi communication signals, the LiFi receiver receives the LiFi signals carrying the information and transforms the LiFi signals into electrical signals, and computer processes the electrical signals for producing an output in a form presentable for the end users.

LiFi removes the limitations that have been put on the user by the radio wave transmission such as Wi-Fi. The advantages include, but are not limited to, reduction in energy consumption requirements for data transmission as the energy consumed by LiFi transmitter and receiver is low as compared to the radio antennae and processing components used in the existing technologies such as Wi-Fi do no, high data rates (that can reach up to 1 gigabit per second), low interference as compared to existing technologies such as Wi-Fi, easy availability of light sources as the LED sources are already used in spaces such as homes, offices, etc., low-cost working components as well as the requirement of fewer components for working as compared to existing wireless communication technologies such as Wi-Fi, enhanced security of signals in a confined space with an opaque boundary as visible light cannot escape through opaque objects.

However, there are some limitations associated with the LiFi communication technology. Even though LiFi communication systems are seen as a solution to security issues (as light cannot pass through opaque walls), they may prove inefficient in guarding against users having access to the space where the LiFi system is installed. This is because the data transmitted in line of sight to the receiver end is of a broadcast nature, as the light is transmitted from the sender to the receiver using air between the sender and the receiver as the medium. For example, in the cases where a malicious user is present in an area where LiFi communication signals reach. If the data is not secured, the malicious user may use the data for wrong purposes. This is a potential risk and particularly more significant in public areas, where the light can be accessed by anyone. Mitigating such risks provides a robust framework for using LiFi communication signals for communication purposes.

Hence, in light of the above discussion, and to mitigate the aforementioned challenges associated with the security of the data signals while using LiFi communication signals for data communication purposes, a system that enhances the security of the signals while using the LiFi communication signals for data communication is disclosed. A solution to this problem lies in encrypting the LiFi communication signals. Cryptographic protection of signals refers to techniques for encrypting signals by transforming the signals into a format that is unreadable to unauthorized users. Cryptographic protection includes encryption, and authentication of the signals at the receiver using a key or token, and decryption of signals based on authentication. For the protection of light signals, generating a specific spectrum of the light signals before transmission of the light signals, and analyzing the received light signals using spectroscopy can be used.

Spectroscopy is a technique that involves determining the energy states of atoms or molecules by analyzing the light absorbed or emitted when they change states. The technique involves spectrum analyzers to measure and visualize the light spectrum, that is, the distribution of power/energy/intensity of light across different frequencies. In the spectroscopy technique, analysis of the change in energies of the states of atoms and/or molecules when light falls on the atoms and/or molecules may determine the structure of the atoms and/or molecules. In the spectroscopy technique, light falling on some material containing certain atoms excites particles of the atoms. Consequently, the particles release energy in the form of emission rays (spectrum rays, which correspond to the photon wavelength). The atoms, molecules, or the structure of the compounds are determined based on the photon rays, that is, the attributes/characteristics of the spectrum rays such as the light intensity for various frequencies. The spectroscopy could be performed by a spectrometer by studying the properties of light, mass, magnetic field, etc. Optical spectrometry involves the analysis of a light spectrum separated by wavelengths. The spectrum radiated can be of two types – absorption spectrum or emission spectrum. An optical emission spectrometer is used to analyze an optical spectrum emitted by an excited sample of atoms/molecules. The excitation could be a result of the application of a spark, plasma, flame, etc. Electrons in atoms absorb energy from the applied energy source and move into higher energy states while returning to the ground state or normal state of the electrons releasing the absorbed energy in the form of photons. No two different element’s atoms can emit photons at the same wavelength. This suggests that once the wavelength of photon emitted due to light passing through a sample compound is known, the element responsible for the emission of the wavelength, and consequently, the atoms/molecules in the sample compound can be determined.

Fundamentally, in the spectrometry technique, the light from a light source is made to fall on a collimator which directs the light at a prism. Further, a wavelength selector (that is, a component that either selects and transmits a narrow band of wavelengths emanating from a broadband optical source or transmits one or more lines from a discrete wavelength source) is placed. The wavelength selector gives a band of light with a measurable width. Also, the absorption spectrum or emission spectrum can be used with different solutions, and the specified spectrum may be sent out. Pertinently, adding something transparent (for example, glass) with specified materials before the light, results in the generation of the absorption spectrum, whereas adding some materials into the light source, results in generation of the emission spectrum. Finally, the light with the desired spectrum is made to fall on the detector (such as, but not limited to, a photodiode) which detects the light and/or the spectrum of the visible light. In an example, some molecules with iron (Fe) atom are iron(III) oxide (Fe₂O₃), iron(II,III) oxide (Fe₃O₄), ferro thiocyanate (Fe(SCN)₂), iron(III) oxide-hydroxide (Fe(OH)₃), iron(II) disulfide (FeS₂), iron(II) sulfide (FeS), iron (II) hydroxide (Fe(OH)₂). Different molecules provide different spectrums of light. Analyzing the spectrum of light, the spectrometer can determine the exact molecule or the combination of molecules present in the material through which the light passed before reaching the spectrometer.

Hence, in a case where only the LiFi communication signals with a specific spectrum are trusted and decoded further for processing and producing the final output, providing the same spectrum is difficult for the malicious user. There are thousands of materials and combinations of the materials that can be used for generating a spectrum of the LiFi communication signals using which the data is communicated. Only a specific set of materials may be used while some materials may be avoided. Thus, there are billions of combinations for the malicious user to try, and providing the materials in the spectrum will be expensive and time consuming. In an example, where there are 1000 compounds among which 4 compounds are selected to generate the spectrum of the LiFi communication signals, then there are 1000*999*998*997/24 (approx. 41.4 Bn) combinations. This would be expensive and time-consuming exercise that may not be even possible for malicious user to practice while trying to tamper with the LiFi communication signals.

In various embodiments of the disclosure, a computer-implemented method for communication using LiFi communication signals is provided. The computer-implemented method includes receiving, by a computer, one or more LiFi communication signals associated with a set of spectrum characteristics. The set of spectrum characteristics is indicative of a set of chemical compounds associated with a light source. The one or more LiFi communication signals are received from the light source associated with a first electronic device. The computer-implemented method further includes analyzing, by the computer, the set of spectrum characteristics of the one or more LiFi communication signals. The computer-implemented method further includes comparing, by the computer, the set of spectrum characteristics of the one or more LiFi communication signals with a specified set of spectrum characteristics based on the analyzing of the set of spectrum characteristics. The computer-implemented method further includes decoding, by the computer, the one or more LiFi communication signals based on the comparing. The analysis of the set of spectrum characteristics of the LiFi communication signals and decoding of the LiFi communication signals only if the set of spectrum characteristics matches with the specified set of spectrum characteristics enhances the security of the LiFi communication signals as only those signals will be decoded whose spectrum matches the specified set of spectrum characteristics. Also, since a large number of combinations of chemical compounds, and therefore, a large number of sets of spectrum characteristics, is possible to generate using various chemical compounds, the security gets enhanced as the signals with any different set of spectrum characteristics are discarded and not decoded for presenting the final output to a user.

In various embodiments of the disclosure, the computer-implemented method further includes determining, by the computer, the set of spectrum characteristics matches the specified set of spectrum characteristics based on the comparing. The computer-implemented method further includes decoding, by the computer, the one or more LiFi communication signals based on the determination that the set of spectrum characteristics matches the specified set of spectrum characteristics.

In various embodiments of the disclosure, the computer-implemented method further includes rendering, by the computer, a notification on a user interface (UI) based on the determination that the set of spectrum characteristics matches with the specified set of spectrum characteristics. Here, if the same set of chemical compounds is present and reflected in the LiFi communication signals received as the specified set of chemical compounds, the set of chemical compounds may also be reported to the user, or at least the presence of the specified set of chemical compounds is indicated to the user.

In various embodiments of the disclosure, the computer-implemented method further includes determining, by the computer, the set of spectrum characteristics differs from the specified set of spectrum characteristics based on the comparing. The computer-implemented method further includes restricting, by the computer, the decoding of the one or more LiFi communication signals based on the determination that the set of spectrum characteristics differs from the specified set of spectrum characteristics. This further enhances the security of the LiFi signals getting decoded as the signals will not be decoded in case the set of spectrum characteristics of the received LiFi communication signals differs from the specified set of spectrum characteristics.

In various embodiments of the disclosure, the computer-implemented method further includes rendering, by the computer, a notification on the UI based on the determination that the set of spectrum characteristics differs from the specified set of spectrum characteristics. If a different set of chemical compounds is present and reflected in the LiFi communication signals received as compared to the specified set of chemical compounds, the set of chemical compounds that is present in the received LiFi communication signals may also be reported to the user, or at least the absence of the specified set of chemical compounds is indicated to the user, so that the user may take proper measures for maintaining strict security of the data signals.

In various embodiments of the disclosure, the light source includes a structure. The structure of the light source includes the set of chemical compounds.

In various embodiments of the disclosure, the light source includes the set of chemical compounds.

In various embodiments of the disclosure, the computer-implemented method further includes transmitting, by the computer, a request for modifying the set of spectrum characteristics. The request is transmitted to the first electronic device. The computer-implemented method further includes receiving, by the computer, a response associated with the modified set of spectrum characteristics based on the transmitted request. The response is received from the first electronic device. This further contributes to security enhancement as when the set of specified spectrum characteristics is modified, the set of chemical compounds is also changed on the sender side. This acts like changing a key to decipher the received signals.

In various embodiments of the disclosure, a computer system for communication using LiFi communication signals is provided. The computer system includes a processor set, one or more computer-readable storage media, and program instructions stored on the one or more computer-readable storage media. The program instructions are executable by the processor set to cause the processor set to receive one or more LiFi communication signals associated with a set of spectrum characteristics. The set of spectrum characteristics is indicative of a set of chemical compounds associated with a light source. The one or more LiFi communication signals are received from the light source associated with a first electronic device. The program instructions further cause the processor set to compare the set of spectrum characteristics of the one or more LiFi communication signals with a specified set of spectrum characteristics. The program instructions further cause the processor set to calculate a difference value between the set of spectrum characteristics of the one or more LiFi communication signals and the specified set of spectrum characteristics based on the comparison of the set of spectrum characteristics of the one or more LiFi communication signals with the specified set of spectrum characteristics. The program instructions further cause the processor set to compare the calculated difference value with a threshold difference value. The program instructions further cause the processor set to decode the one or more LiFi communication signals based on the comparison of the calculated difference value with the threshold difference value.

In various embodiments of the disclosure, the program instructions further cause the processor set to determine, the set of spectrum characteristics matches the specified set of spectrum characteristics based on the comparison of the calculated difference value with the threshold difference value. The program instructions further cause the processor set to decode the one or more LiFi communication signals based on the determination that the set of spectrum characteristics matches the specified set of spectrum characteristics.

In various embodiments of the disclosure, the program instructions further cause the processor set to render a notification on a user interface (UI) based on the determination that the set of spectrum characteristics matches with the specified set of spectrum characteristics.

In various embodiments of the disclosure, the program instructions further cause the processor set to determine, the set of spectrum characteristics differs from the specified set of spectrum characteristics based on the comparison of the calculated difference value with the threshold difference value. The program instructions further cause the processor set to restrict the decode of the one or more LiFi communication signals based on the determination that the set of spectrum characteristics differs from the specified set of spectrum characteristics.

In various embodiments of the disclosure, the program instructions further cause the processor set to render a notification on a user interface (UI) based on the determination that the set of spectrum characteristics differs from the specified set of spectrum characteristics.

In various embodiments of the disclosure, the program instructions further cause the processor set to transmit a request for modification of the set of spectrum characteristics to the first electronic device. The request is transmitted to the first electronic device. The program instructions further cause the processor set to receive a response associated with the modified set of spectrum characteristics based on the transmitted request. The response is received from the first electronic device.

In various embodiments of the disclosure, a computer program product for communication using LiFi communication signals is provided. The computer program product includes one or more computer-readable storage media. The program instructions stored on the one or more computer-readable storage media to perform operations. The operations include receiving the one or more LiFi communication signals associated with a set of spectrum characteristics. The set of spectrum characteristics is indicative of a set of chemical compounds associated with a light source. The one or more LiFi communication signals are received from the light source associated with a first electronic device. The operations include analyzing the set of spectrum characteristics of the one or more LiFi communication signals. The operations include comparing the set of spectrum characteristics of the one or more LiFi communication signals with a specified set of spectrum characteristics based on the analyzing of the set of spectrum characteristics. The operations include decoding the one or more LiFi communication signals based on the comparing.

In various embodiments of the disclosure, the operations include determining the set of spectrum characteristics matches the specified set of spectrum characteristics based on the comparing. The operations include decoding the one or more LiFi communication signals based on the determination that the set of spectrum characteristics matches the specified set of spectrum characteristics.

In various embodiments of the disclosure, the operations include rendering a notification on a user interface (UI) based on the determination that the set of spectrum characteristics matches with the specified set of spectrum characteristics.

In various embodiments of the disclosure, the operations include determining, the set of spectrum characteristics differs from the specified set of spectrum characteristics based on the comparing. The operations include restricting the decoding of the one or more LiFi communication signals based on the determination that the set of spectrum characteristics differs from the specified set of spectrum characteristics.

In various embodiments of the disclosure, the operations include rendering a notification on a user interface (UI) based on the determination that the set of spectrum characteristics differs from the specified set of spectrum characteristics.

In various embodiments of the disclosure, the operations include transmitting a request for modifying the set of spectrum characteristics. The request is transmitted to the first electronic device. The operations include receiving a response associated with the modified set of spectrum characteristics based on the transmitted request. The response is received from the first electronic device.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the disclosure, is not to be construed as storage in the generation of transitory signals per se, such as radio waves or freely propagating electromagnetic waves, electromagnetic waves propagating through a waveguide, light pulses passing through a fiber optic cable, electrical signals communicated through a wire, and/or different forms of transmission media. As will be understood by those of skill in the art, data is typically moved at some occasional points in time during normal operations of a storage device, such as during access, de-fragmentation, or garbage collection, but this does not render the storage device as transitory because the data is not transitory while the data is stored.

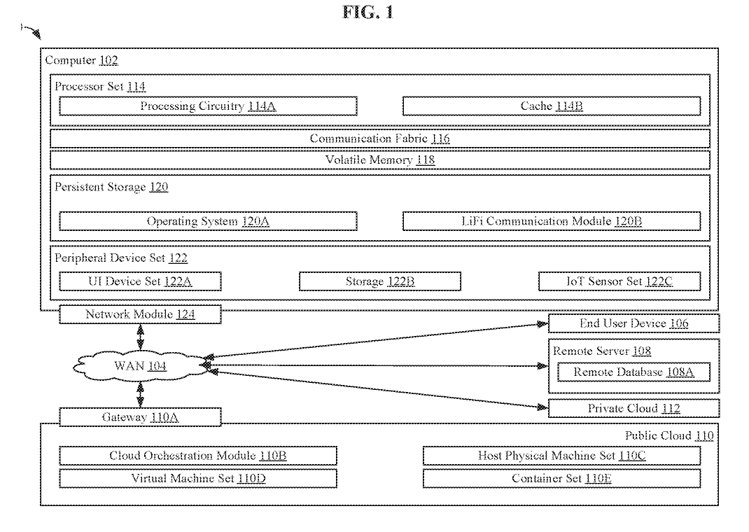

FIG. 1 is a diagram that illustrates a computing environment 100 for communication using light fidelity (LiFi) communication signals, in accordance with various embodiments of the disclosure. The diagram contains an exemplary environment for the execution of at least one module involved in performing the methods, such as a LiFi communication module 120B associated with generating, receiving, and analyzing LiFi communication signals for communication using the LiFi communication signals. In addition to the LiFi communication module 120B, computing environment 100 includes, for example, a computer 102, a wide area network (WAN) 104, an end user device (EUD) 106, a remote server 108, a public cloud 110, and a private cloud 112. In various embodiments of the disclosure, the computer 102 includes a processor set 114 (including a processing circuitry 114A and a cache 114B), a communication fabric 116, a volatile memory 118, a persistent storage 120 (including an operating system 120A and the LiFi communication module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or alternative forms of wearable computer, a mainframe computer, a quantum computer, or any form of a computer or a mobile device now known or to be developed in the future that may run a program, accessing a network or querying a database, such as a remote database 108A. As is well understood in the art of computer technology, and depending upon the technology, the performance of a computer-implemented method may be distributed among multiple computers and/or between multiple locations. In various embodiments of the disclosure, in this presentation of the computing environment 100, detailed discussion is focused on a single computer, specifically the computer 102, to keep the presentation as simple as possible. The computer 102 may be located in a cloud, even though the computer 102 is not shown in a cloud in FIG. 1. In various embodiments, computer 102 is not located in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the storage media discussed below. The program instructions, and associated data, are accessed by the processor set 114 to control and direct the performance of the methods. In computing environment 100, at least some of the instructions for performing the methods may be stored in the LiFi communication module 120B in persistent storage 120.

The communication fabric 116 is the signal conduction path that allows communication between various components of computer 102 . Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 may be characterized by random access, at least in case affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The LiFi communication module 120B typically includes at least one module involved in performing the methods.

The peripheral device set 122 includes the set of peripheral devices of computer 102. Data communication connections between the peripheral devices and the various components of computer 102 may be implemented in various ways, such as Bluetooth connections, near-field communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 has a large amount of storage (for example, where computer 102 locally stores and manages a large database) then this storage may be provided by peripheral storage devices designed for storing large amounts of data, such as a storage area network (SAN) that is shared by multiple, geographically distributed computers. The IoT sensor set 122C is made up of sensors that can be used in Internet of Things applications. For example, one sensor may be a thermometer, and a sensor may be a motion detector.

The network module 124 is the collection of computer software, hardware, and firmware that allows communication between computer 102 and computers connected through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the methods can typically be downloaded to computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer functions, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments (VCEs) that run on various computers making up the computers of the host physical machine set 110C, which is the universe of physical computers in and/or available to the public cloud 110. The VCEs typically take the form of virtual machines from the virtual machine set 110D and/or containers from the container set 110E. The VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in these isolated user-space instances. A computer program running on an ordinary operating system can utilize resources of that computer, such as connected devices, files and folders, network shares, CPU power, and quantifiable hardware functions. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of diverse types (for example, private, community, or public cloud types), often respectively implemented by different vendors. Each cloud of the multiple clouds remains a separate and discrete entity, but the larger hybrid cloud architecture is bound together by standardized or proprietary technology that supports orchestration, management, and/or data/application portability between the multiple constituent clouds. In various embodiments of the disclosure, the public cloud 110 and the private cloud 112 are both part of a larger hybrid cloud.

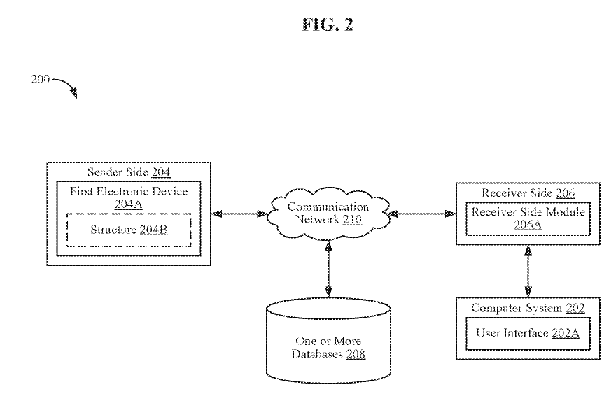

FIG. 2 is a diagram that illustrates an environment for communication using LiFi communication signals, in accordance with various embodiments of the disclosure. FIG. 2 is explained in conjunction with elements from FIG. 1. With reference to FIG. 2, there is shown a diagram of a network environment 200. The network environment 200 includes a computer system 202, a sender side 204 that includes a first electronic device 204A and a structure 204B, a receiver side 206 that includes a receiver side module 206A, one or more databases 208, and a communication network 210. In various embodiments of the disclosure, the computer system 202 is an exemplary embodiment of the computer 102 in FIG. 1. In various embodiments of the disclosure, the first electronic device 204A is configured to generate communication signals carrying data for transmission using LiFi communication.

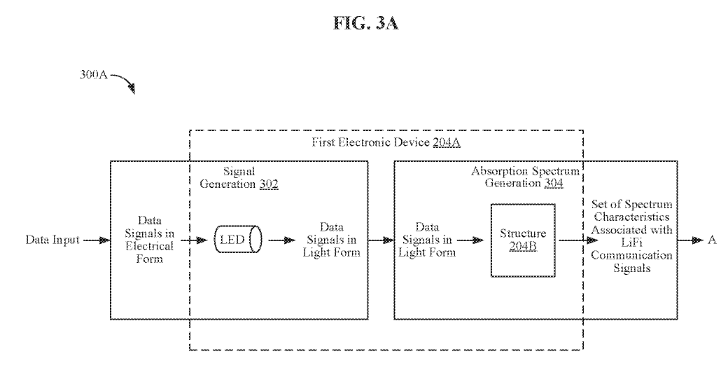

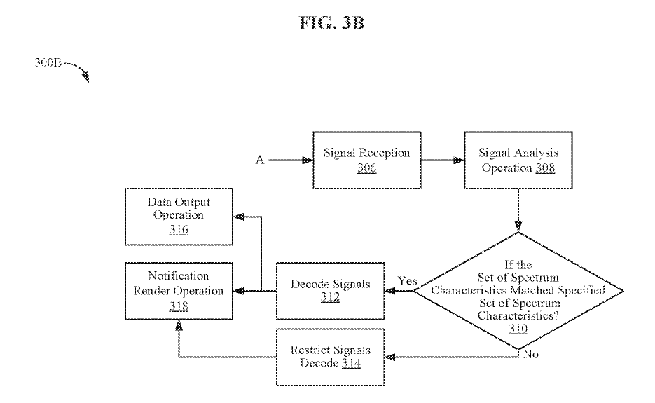

The computer system 202 includes suitable logic, circuitry, and/or interfaces for communication using LiFi communication signals. The computer system 202 is configured to obtain a data from the receiver side module 206A at the receiver side 206. In various embodiments of the disclosure, the receiver side module 206A is present at the receiver side 206. In various embodiments of the disclosure, the receiver side module 206A includes, but is not limited to, a LiFi receiver system. In various embodiments of the disclosure, the LiFi receiver system includes a spectrum detector component such as, but not limited to, an inductively coupled plasma-optical emission spectroscopy (ICP-OES) technique based spectrometer device. The ICP-OES technique based spectrometer device is used to identify the atomic composition of a particular sample through which the light rays have passed. In various embodiments of the disclosure, the receiver side module 206A includes a photodetector, such as, but not limited to, a photodiode. In various embodiments of the disclosure, the photodiode is integrated with the ICP-OES technique based spectrometer device. In various embodiments of the disclosure, the photodiode is present externally but operably coupled to the ICP-OES technique based spectrometer device. In various embodiments of the disclosure, at the sender side 204, the LiFi communication signals (in the form of light rays) pass through the structure 204B. The structure 204B includes a set of chemical compounds. When the LiFi communication signals pass through said structure, a set of spectrum characteristics is generated. Further, the receiver side module 206A is configured to receive one or more LiFi communication signals with the set of spectrum characteristics. The ICP-OES technique based spectrometer device of the receiver side module 206A detects the presence or absence of a specified set of chemical compounds. For the detection of the presence or absence of a specified set of chemical compounds, the ICP-OES technique based spectrometer device is configured to analyze the received LiFi communication signals (also referred to as one or more LiFi communication signals). Further details regarding the detection of the presence or absence of a specified set of chemical compounds are provided in the disclosure with reference to FIG. 3B. An output of the receiver side module 206A may be fed to the computer system 202 at the receiver side 206. In various embodiments of the disclosure, the output from the receiver side module 206A includes a set of results that are generated from the analysis performed by the receiver side module 206A. For example, the receiver side module 206A analyses the set of spectrum characteristics of the received LiFi communication signals, and based on the analysis, the receiver side module 206A generates the output including a list of chemical compounds that were present at the sender side 204 while the set of spectrum characteristics were generated. The output of the receiver side module 206A is provided as input to the computer system 202 on the receiver side 206.

In various embodiments of the disclosure, the computer system 202 and the receiver side module 206A may collectively form a single entity. In various embodiments of the disclosure, the computer system 202 may be an entity that may be separated from the receiver side module 206A but is operably coupled with the receiver side module 206A. Thus, in various embodiments of the disclosure, where the computer system 202 and the receiver side module 206A form a single entity, the input to the computer system 202 is the LiFi communication signals received at the receiver side 206 from the sender side 204. In various embodiments of the disclosure, where the computer system 202 and the receiver side module 206A are separate entities, the input to the computer system 202 includes at least a result of the analysis made by the receiver side module 206A.

In various embodiments of the disclosure, the computer system 202 is further configured to analyze the input received from the receiver side module 206A. The computer system 202 is further configured to decide whether to allow the LiFi communication signals to get decoded further or block the LiFi communication signals. In various embodiments of the disclosure, the decision by the computer system 202, whether to allow the LiFi communication signals to get decoded further or block the LiFi communication signals, is made based on whether the set of spectrum characteristics of the received LiFi communication signals matches a specified set of spectrum characteristics or not. In various embodiments of the disclosure, for the purpose of making the decision, the computer system 202 compares the set of spectrum characteristics of the received LiFi communication signals with the specified set of spectrum characteristics.

Examples of the computer system 202 include but are not limited to, a server, a computing device, a virtual computing device, a mainframe machine, a computer workstation, a smartphone, a cellular phone, a mobile phone, or a consumer electronic (CE) device. In various embodiments of the disclosure, the computer system 202 may be embodied as a cloud-based service, a cloud-based application, a cloud-based platform, a remote server-based service, a remote server-based application, a remote server-based platform, or a virtual computing system.

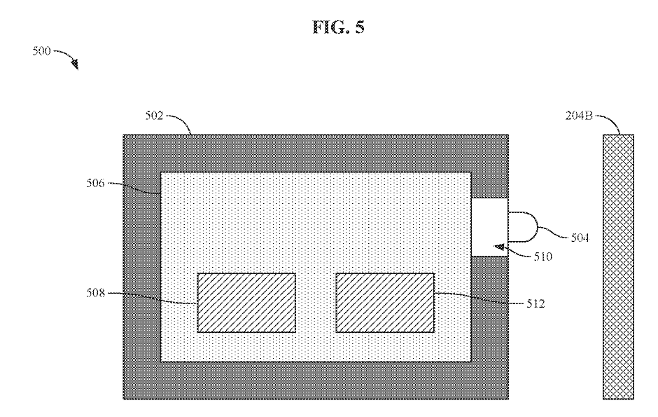

In various embodiments of the disclosure, the sender side 204 includes at least a first electronic device 204A. The first electronic device 204A includes, but is not limited to, a LiFi transmitter system. This LiFi transmitter system may further include components such as, but not limited to, a bulb assembly, a power amplifier (PA) circuit, and a printed circuit board (PCB). Further details on the components of the first electronic device 204A are explained with respect to FIG. 5 in this disclosure.

In various embodiments of the disclosure, the first electronic device 204A is connected to a data source which is responsible for providing the data to be transmitted via the LiFi communication signals. Examples of the data source include, but are not limited to, a computing machine including an input device such as a touchscreen, a keyboard, a mouse, or any such input device, a smartphone, an internet router, or any communication device that can be used to receive data from a network or device, and may forward the received data to the first electronic device 204A. In various embodiments of the disclosure, after the data to be transmitted is provided to the first electronic device 204A, the data signal is converted into light signals for being transmitted as LiFi communication signals. The PCB acts to control these functions for the bulb assembly to provide output in the form of light signals carrying data. The light signals carrying data are referred to as LiFi communication signals. For this purpose, the PCB may include various electronic circuitry, such as integrated circuits, field programmable gate arrays (FPGAs), programmable logic circuits (PLCs), microprocessors, microcontrollers, or any such electronic circuits and devices, in any combination thereof, that are configured to execute one or more operations associated with the generation of the LiFi communication signals carrying the data that is to be transmitted from the sender side 204 to the receiver side 206.

In various embodiments of the disclosure, the first electronic device 204A further includes the structure 204B. In various embodiments of the disclosure, the structure 204B is a transparent structure including a transparent material, such as, but not limited to, glass, plastic, polycarbonate, etc. In an embodiment, the structure 204B may include impurities in the form of materials such as chemical compounds. The chemical compounds are used to generate a spectrum of light when the LiFi communication signals in the form of visible light fall on the structure 204B. For example, different sets of spectrum properties/characteristics are generated when the visible light falls in different chemical compounds such as, but not limited to, iron(III) oxide (Fe₂O₃), iron(II, III) oxide (Fe₃O₄), ferro thiocyanate (Fe(SCN)₂), iron(III) oxide-hydroxide (Fe(OH)₃), iron(II) disulfide (FeS₂), iron(II) sulfide (FeS), iron (II) hydroxide (Fe(OH)₂).

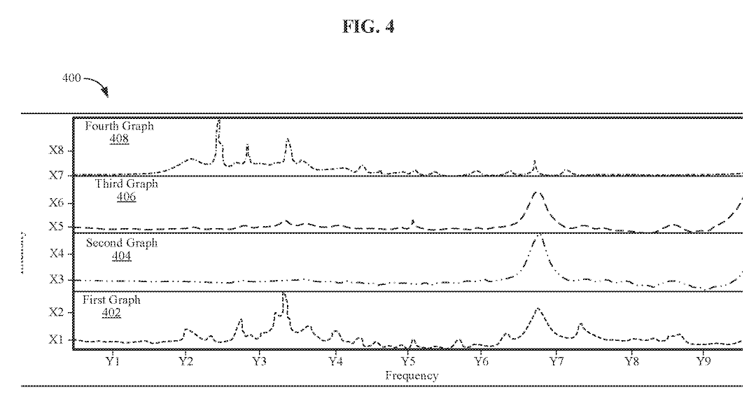

In various embodiments of the disclosure, the structure 204B is integrated with the first electronic device 204A. In various embodiments of the disclosure, the structure 204B is present external to the first electronic device 204A but is operably coupled to the first electronic device 204A. The structure 204B is configured to generate a set of spectrum characteristics of light when the light rays are input to the structure 204B. Consequently, when the LiFi communication signals carrying data to be transmitted, are input to the structure 204B, then the structure 204B generates the set of spectrum characteristics of the received LiFi communication signals. Exemplary spectrum characteristics/patterns generated from different molecules/chemical compounds are shown in FIG. 4 and discussed later with reference to FIG. 4 in this disclosure.

Each database of the one or more databases 208 corresponds to an organized collection of data that may be stored and accessed electronically from a computer system (such as the computer system 202). In various embodiments of the disclosure, the one or more databases 208 store one or more attributes related to a specified set of spectrum characteristics. In various embodiments of the disclosure, the specified set of spectrum characteristics is also referred to as the desired spectrum, as the received LiFi communication signals at the receiver side 206 are decoded in case the set of spectrum characteristics of the received LiFi communication signals matches the specified set of spectrum characteristics. Each database of the one or more databases 208 is designed to manage, store, retrieve, and update data efficiently. Examples of each database of the first set of databases 208 may include, but are not limited to, a relational database, a not only structured query language (NoSQL) database, a hierarchical database, a data warehouse, and a distributed database. The one or more databases may be used to store some data that is used in the method for communication using the LiFi communication signals. Examples of the data include, but are not limited to, a specified set of spectrum characteristics, threshold difference value, etc. which are explained later in this disclosure.

The communication network 210 includes, but is not limited to air, water, vacuum, or any such medium for communication of light signals between the sender side 204 and the receiver side 206. The communication network 210 serves as an interface between the sender side 204 and the receiver side 206 particularly for transmitting light signals carrying data. For example, the LiFi communication signals generated at the sender side 204 are transmitted to the receiver side 206 via air, that is, air exists between the sender side 204 and the receiver side 206. In such cases, air serves as the communication network 210.

In operation, the first electronic device 204A receives data to be communicated to the receiver side 206. In various embodiments of the disclosure, upon receiving the data from the data source, the first electronic device 204A generates LiFi communication signals to be communicated to the receiver side 206. Further, the LiFi communication signals pass through the structure 204B for the generation of a set of spectrum characteristics of the LiFi communication signals. Thereafter, the LiFi communication signals with the generated set of spectrum characteristics are transmitted by the first electronic device 204A from the sender side 204 to the receiver side 206.

In various embodiments of the disclosure, the receiver side module 206A includes, but is not limited to, the spectrometer device and the computer system 202. In various embodiments of the disclosure, the receiver side module 206A receives the LiFi communication signals transmitted from the first electronic device 204A. The receiver side module 206A analyses the received LiFi communication signals. More particularly, in various embodiments of the disclosure, the analysis is performed by a spectrometer device of the receiver side module 206A, such as, but not limited to, an ICP-OES technique based spectrometer device present at the receiver side 206. Consequently, in various embodiments of the disclosure, the receiver side module 206A is configured to analyze the received LiFi communication signals. Further, the receiver side module 206A is configured to compare the set of spectrum characteristics of the received LiFi communication signals with a specified set of spectrum characteristics based on the analysis of the set of spectrum characteristics. Further, in various embodiments of the disclosure, the computer system 202 analyses the results of the analysis of the received LiFi communication signals and decides whether to trust the received LiFi communication signals and allow the LiFi communication signals to pass for further processing, or to restrict the received LiFi communication signals. In an embodiment of the disclosure, further processing involves decoding the received LiFi communication signals. Further, in an embodiment of the disclosure, the computer system 202 is configured to trust the received LiFi communication signals in case the set of spectrum characteristics of the received LiFi communication signals matches the specified set of spectrum characteristics. In an embodiment of the disclosure, the computer system 202 is configured to suspect the received LiFi communication signals in case the set of spectrum characteristics of the received LiFi communication signals matches the specified set of spectrum characteristics.

In various embodiments of the disclosure, the computer system 202 is configured to decode the received LiFi communication signals based on the comparing of the calculated difference value with a threshold difference value. The threshold difference value may be a numerical value that may be indicative of a maximum deviation of the spectrum pattern of the received one or more LiFi communication signals from the specified spectrum pattern. In various embodiments of the disclosure, the decode of the received LiFi communication signals corresponds to the decoding of the received LiFi communication signals and allows the decoded LiFi communication signals to pass for further processing. The computer system 202 may be configured to render the data generated by the decoding of the received LiFi communication signals. The data may be rendered on a user interface (UI) 202A of the computer system 202. In various embodiments of the disclosure, the decode of the received LiFi communication signals includes restricting the received LiFi communication signals from getting decoded and discarding the received LiFi communication signals.

FIG. 3A is a diagram that illustrates exemplary operations at the sender side 204 for communication using LiFi communication signals, in accordance with various embodiments of the disclosure. FIG. 3A is explained in conjunction with elements from FIG. 1, and FIG. 2. With reference to FIG. 3A, there is shown a block diagram 300A that illustrates exemplary operations from 302 to 304, as described herein. Although illustrated with discrete blocks, the exemplary operations associated with one or more blocks of the block diagram 300A may be divided into additional blocks, combined into fewer blocks, or eliminated, depending on the particular implementation.

At 302, a signal generation operation is executed. In the signal generation operation, the first electronic device 204A is configured to receive data from the data source. The received data refers to the data that is to be transmitted from the sender side 204 to the receiver side 206, using the LiFi communication signals. In various embodiments of the disclosure, the first electronic device 204A includes a light source. The light source includes, but is not limited to, a light-emitting diode (LED) (also referred to as LED source) which is configured to generate light rays. In various embodiments of the disclosure, the light source is embedded in the first electronic device 204A. In various embodiments of the disclosure, the light source is present as a separate entity and is operably coupled to the first electronic device 204A. Examples of light sources include, but are not limited to, a light-emitting diode, or a combination of LED with the set of chemical compounds. In various embodiments of the disclosure, the light source includes the structure 204B (including the set of chemical compounds) placed in front of the LED source in such a manner that when the LiFi communication signals carrying the data fall on the structure 204B, an absorption spectrum of the LiFi communication signals is generated. In various embodiments of the disclosure, the light source includes a set of chemical compounds in such a manner that when the LiFi communication signals carrying the data are generated from the light source, an emission spectrum of the LiFi communication signals is generated.

In various embodiments of the disclosure, the first electronic device 204A is configured to receive the data to be transmitted using the LiFi communication signals. To receive the data, in various embodiments of the disclosure, the first electronic device 204A is connected to a data source which is responsible for providing the data to be transmitted using the LiFi communication signals. Examples of the data source include, but are not limited to, a computing machine including an input device such as a touchscreen, a keyboard, a mouse, or any such input device, a smartphone, an internet router, or any communication device that can be used to receive data from a network or device and may forward the received data to the first electronic device 204A. The data is provided by the data source to the first electronic device 204A in the form of electrical signals. In various embodiments of the disclosure, the first electronic device 204A, after receiving the data to be transmitted, is configured to convert the data signals from electrical signals to light rays for being transmitted as one or more LiFi communication signals.

At 304, spectrum generation operation is executed. In the spectrum generation operation, the spectrum characteristics of the one or more LiFi communication signals (shown as A in FIG. 3A) are generated by the application of the chemical compounds on one or more LiFi communication signals. Here, the spectrum characteristics refer to the pattern of the spectrum of visible light that is generated as a combination of light intensity or energy across various frequencies of light signals. For generating the spectrum characteristics, a single chemical compound or a combination of multiple chemical compounds is used. Pertinently, throughout the disclosure, the chemical compounds are not limited to only compounds but also refer to elements such as, but not limited to, aluminum, gallium, indium, etc., alloys such as but not limited to, phosphide alloys and indium gallium nitride alloys, as well as various derivatives of elements such as, but not limited to, Fe₂O₃, Fe₃O₄, Fe(SCN)₂, Fe(OH)₃, FeS₂, FeS, Fe(OH)₂, etc.

In various embodiments of the disclosure, the light source includes the structure 204B, and the structure 204B includes the set of chemical compounds. For example, the structure 204B may be a piece of glass induced with a set of chemical compounds. Overall the light source includes the LED placed behind the structure 204B. When one or more LiFi communication signals from the LED pass through structure 204B, certain frequencies of the one or more LiFi communication signals are absorbed by the transparent material of the structure 204B according to the chemical compounds. This results in the generation of the absorption spectrum of the light rays, and since the one or more LiFi communication signals include the data that is to be transmitted from the first electronic device 204A, the absorption spectrum of the one or more LiFi communication signals is generated.

In various embodiments, where the LED includes the set of chemical compounds, the light rays generated from the light source include the spectrum characteristics of the set of chemical compounds. For example, the LED is induced with a set of chemical compounds, say, chemical X, so when the light rays carrying the data signals are emitted from the LED, the spectrum characteristics of the chemical X may be emitted with the light rays carrying the data signals. This means the light source includes an LED, and the LED further includes the set of chemical compounds. This results in the generation of the emission spectrum of the one or more LiFi communication signals. A set of non-limiting examples of exemplary spectrums generated by using various chemical compounds is provided in FIG. 4. Pertinently, the spectrums shown in FIG. 4 are exemplary, provided for understanding purposes only, and may not conform to the actual spectrums generated by light sources with chemical compounds. The spectrum generated pertains to the chemical compounds that are induced in the LED or included in the transparent material of the structure 204B. Pertinently, no two different chemical compounds generate the same spectrum, and therefore, the set of spectrum characteristics is indicative of the set of chemical compounds associated with the light source. Thus, if one knows the pattern of the spectrum, then the chemical compounds can be determined by analyzing the spectrum characteristics or the pattern of the spectrum.

In various embodiments of the disclosure, the one or more LiFi communication signals (shown as A in FIG. 3B), to be transmitted to the receiver side 206, are fed to the structure 204B including the set of chemical compounds. Consequently, the absorption spectrum of the one or more LiFi communication signals, conforming to the set of chemical compounds is generated at absorption spectrum generation operation at 304. In various embodiments of the disclosure, the set of chemical compounds included in the structure 204B is referred to as a first set of chemical compounds. Thus, the first set of chemical compounds is used to generate the absorption spectrum of the one or more LiFi communication signals. In various embodiments, when the one or more LiFi communication signals are generated by the LED including the first set of chemical compounds, the emission spectrum of the one or more LiFi communication signals is generated. In various embodiments of the disclosure, the set of chemical compounds included in the LED is referred to as a second set of chemical compounds. Thus, the second set of chemical compounds is used to generate the emission spectrum. In an embodiment of the disclosure, the first set of chemical compounds is different from the second set of chemical compounds. Although, FIG. 3A depicts the generation of the absorption spectrum at 304, however, the disclosure encompasses the generation of the absorption spectrum generation as well as the emission spectrum at 304. In various embodiments of the disclosure, both absorption spectrum and emission spectrum are generated in case the LED includes the second set of chemical compounds and the light generated from the LED source is made to fall on the structure 204B including the first set of chemical compounds. In various embodiments, only absorption spectrum is generated as the one or more LiFi communication signals from the LED fall on the structure 204B including the first set of chemical compounds. In various embodiments, only the emission spectrum is generated as the one or more LiFi communication signals are produced by the LED that includes the second set of chemical compounds.

Using a combination of chemical compounds for generating the emission spectrum or the absorption spectrum is like encoding the data signals in the present disclosure with the spectrum as the key. This enhances security of the one or more LiFi communication signals as the one or more LiFi communication signals are generally of a broadcast nature. For example, the one or more LiFi communication signals carrying data are transmitted from the sender side 204 to the receiver side 206. As the LiFi communication signals are light signals and cannot pass through opaque objects, both the sender side 204 and the receiver side 206 are present in a confined geographical space. The one or more LiFi signals are broadcasted for the receiver side module 206A to detect the one or more LiFi communication signals. Therefore, the one or more LiFi communication signals are available to anyone present in the confined geographical space. However, the one or more LiFi communication signals can be decoded only if the key is known. Here the set of chemical compounds acts as the key to decode the one or more LiFi communication signals, as the one or more LiFi communication signals broadcasted for the receiver side module 206A are decoded only if the spectrum characteristics determined at the receiver side module 206A conform to the information of the set of chemical compounds that may be stored at the receiver side module 206A. For example, the receiver side module 206A contains information about the set of chemical compounds that the set of chemical compounds includes 50% chemical P and 50% chemical Q. Now, the spectrum characteristics that are generated by the combination of 50% chemical P and 50% chemical Q are unique in such as way that no combination of chemical compounds different than 50% chemical P and 50% chemical Q can produce the spectrum characteristics that are generated by the combination of 50% chemical P and 50% chemical Q. So when the receiver side module 206A determines the spectrum characteristics of the received LiFi signals, the determination that whether the spectrum characteristics of the received LiFi signals have been generated by the combination of 50% chemical P and 50% chemical Q or not can be made. Also, the one or more LiFi communication signals may be decoded only if the set of chemical compounds is known. In this way, the set of chemical compounds acts as a key to decode the one or more LiFi communication signals at the receiver side 206.

FIG. 3B is a diagram that illustrates exemplary operations at the receiver side 206 for communication using LiFi signal communication, in accordance with various embodiments of the disclosure. FIG. 3B is explained in conjunction with elements from FIG. 1, FIG. 2, and FIG. 3A. With reference to FIG. 3B, there is shown a block diagram 300B that illustrates exemplary operations from 306 to 318, as described herein. The exemplary operations illustrated in the block diagram 300B may start at 306 and may be performed by any computing system, apparatus, or device, such as by the computer 102 of FIG. 1 or the computer system 202 of FIG. 2, in combination with the receiver side module 206A. Although illustrated with discrete blocks, the exemplary operations associated with one or more blocks of the block diagram 300B may be divided into additional blocks, combined into fewer blocks, or eliminated, depending on the particular implementation.

At 306, a signal reception operation is executed. In the signal reception operation, the receiver side module 206A is configured to receive the one or more LiFi communication signals (hereinafter, also referred to as received LiFi communication signals). In various embodiments of the disclosure, the receiver side module 206A includes a detector device. In a non-limiting example, the detector device is a photodiode. In various embodiments of the disclosure, the receiver side module 206A includes an inductively coupled plasma-optical emission spectroscopy (ICP-OES) technique based spectrometer device. The ICP-OES technique based spectrometer device is configured to determine the set of chemical compounds by analyzing the spectrum characteristics of the LiFi communication signals.

In various embodiments of the disclosure, the LiFi communication signals received at the receiver side module 206A are associated with the set of spectrum characteristics which is analyzed further for trusting or suspecting the received LiFi communication signals. In various embodiments of the disclosure, the set of spectrum characteristics is one of an absorption spectrum or an emission spectrum.

At 308, a signal analysis operation is executed. In the signal analysis operation, the receiver side module 206A is configured to analyse the received LiFi communication signals to determine the set of chemical compounds at the sender side 204. In case emission spectrum is received with LiFi communication signals, the set of chemical compounds includes the second set of chemical compounds, and in case absorption spectrum is received with LiFi communication signals, the set of chemical compounds includes the first set of chemical compounds. In various embodiments of the disclosure, for analyzing the received LiFi communication signals, the ICP-OES technique based spectrometer device, is used. The ICP-OES technique based spectrometer device determines the set of chemical compounds present at the sender side 204.

In various embodiments of the disclosure, at 308, the receiver side module 206A is configured to determine a set of spectrum characteristics of the received LiFi communication signals. The set of spectrum characteristics of the received LiFi communication signals refers to the pattern of the spectrum of the received LiFi communication signals. The analysis of the received LiFi communication signals includes determining the intensity value of light signals at each frequency value of the light signals in visible light spectrum range. Thus, the set of spectrum characteristics of the received LiFi communication signals is generated by analysing the received LiFi communication signals. Further, the results of the analysis are transmitted to the computer system 202 connected to the receiver side module 206A, to determine whether the set of spectrum characteristics of the received LiFi communication signals matches the specified set of spectrum characteristics or not.

In various embodiments of the disclosure, the receiver side module 206A is configured to analyze the spectrum characteristics of the received LiFi communication signals to determine the set of chemical compounds present at the sender side 204. In such cases, the list of the set of chemical compounds is also communicated by the receiver side module 206A to the computer system 202. In various embodiments of the disclosure, the computer system 202 is configured to compare the list of the set of chemical compounds with a specified set of chemical compounds to decide whether to trust the LiFi communication signals or to suspect the LiFi communication signals.

At 310, the computer system 202 is configured to determine whether the set of spectrum characteristics of the received LiFi communication signals matches the specified set of spectrum characteristics or not. In various embodiments of the disclosure, the specified set of spectrum characteristics includes the pattern of the specified set of spectrum characteristics. In various embodiments of the disclosure, the one or more databases 208 operably coupled to the computer system 202 are configured to store the specified set of spectrum characteristics. The specified set of spectrum characteristics is in conformation with the chemical compounds that are desired to be included at the sender side 204. For example, the desired set of chemical compounds to be included at the sender side 204 includes a combination of 20% chemical A + 30% chemical B + 50% chemical C, then the specified set of spectrum characteristics stored in the one or more databases 208 conform to the same combination of 20% chemical A + 30% chemical B + 50% chemical C, and no chemical compound different from chemical A, chemical B, and chemical C. Thus, the specified set of spectrum characteristics acts as a key for the received LiFi communication signals to be deciphered/decoded, as only the LiFi communication signals with the set of spectrum characteristics matching the specified set of spectrum characteristics are trusted by the computer system 202 to allow to pass through for decoding to further generate the final output.

In various embodiments of the disclosure, at the compare operation at 310, the computer system 202 is configured to determine whether the set of spectrum characteristics matches the specified set of spectrum characteristics or not. Here, for example, a deviation of the intensity of light (of the one or more LiFi signals) may be calculated for each frequency value of the light (of the one or more LiFi signals) for the comparison. In some techniques for comparison, pattern deviation calculation techniques or visualisation methods that are known in the art may be used for determining the deviation or similarity between the pattern of the specified set of spectrum characteristics and the pattern of the set of spectrum characteristics of the received LiFi communication signals.

In various embodiments of the disclosure, where at 308, the set of chemical compounds present at the sender side 204 is determined based on the analyzing of the set of spectrum characteristics of the received LiFi communication signals, then at 310, the computer system 202 is configured to compare the determined set of chemical compounds with the specified set of chemical compounds. The specified set of chemical compounds corresponds to the specified set of spectrum characteristics (that is, the specified set of chemical compounds is the set of chemical compounds that would generate the specified set of spectrum characteristics).

Based on the comparison of the set of spectrum characteristics with the specified set of spectrum characteristics, the computer system 202 is configured to calculate a difference value that is indicative of a deviation of values of intensity in the set of spectrum characteristics of the received LiFi communication signals from the corresponding values of intensity in the specified set of spectrum characteristics. The calculated difference value may be, for example, a mean value for the difference values of intensity for frequencies in the set of spectrum characteristics of the one or more LiFi communication signals and the specified set of spectrum characteristics. For example, the set of spectrum characteristics of the received LiFi communication signals includes intensity values i₁, i₂, i₃, and i₄ at frequency values f₁, f₂, f₃, and f₄ respectively, and the specified set of spectrum characteristics includes intensity values i₅, i₆, i₇, and i₈ at frequency values f₁, f₂, f₃, and f₄ respectively. The difference values may be, for example, d₁, d₂, d₃, and d₄, where d₁ is difference value between i₁ and i₅, d₂ is difference value between i₂ and i₆, d₃ is the difference value between i₃ and i₇, and d₄ is difference value between i₄ and i₈. In this example, the calculated difference value may be the mean of difference values d₁, d₂, d₃, and d₄. Alternatively, the difference value may be calculated as an average value, root mean square value, etc. of the difference values d₁, d₂, d₃, and d₄.

In various embodiments of the disclosure, the operation at 310 is based on the calculated difference value and the threshold difference value. In various embodiments of the disclosure, the one or more databases 208 are configured to store the threshold difference value. The threshold difference value may be indicative of a maximum deviation of the spectrum pattern of the received one or more LiFi communication signals from the specified spectrum pattern. In case the calculated difference value is less than the threshold difference value, then the computer system 202 is configured to determine that the set of spectrum characteristics of the one or more LiFi communication signals matches with the specified set of spectrum characteristics. In that case, the one or more LiFi communication signals may be allowed further to be decoded and presented to the user as the output after final decoding and processing.

In various embodiments of the disclosure, the computer system 202 is configured to determine that the set of spectrum characteristics of the received LiFi communication signals differs from the specified set of spectrum characteristics based on the calculated difference value and the threshold difference value. The calculated difference value being greater than the threshold difference value indicates that the pattern of the set of spectrum characteristics differs from the specified set of spectrum characteristics.

In various embodiments of the disclosure, at the compare operation at 310, the computer system 202 is configured to compare the determined set of chemical compounds with the specified set of chemical compounds. In such case, the received LiFi communication signals would be allowed to pass only if the determined set of chemical compounds exactly matches with the specified set of chemical compounds. For example, the specified set of chemical compounds is a combination of 20% chemical A + 30% chemical B + 50% chemical C. In case the determined set of chemical compounds is the same combination of 20% chemical A + 30% chemical B + 50% chemical C, and only chemical A, chemical B, and chemical C are present in the determined set of chemical compounds, then the LiFi communication signals can be trusted. In case there is any deviation in the reported set of chemical compounds from the specified set of chemical compounds, then the LiFi communication signals would be restricted from getting decoded. For example, the deviation is reported when there is an extra compound that is reported additional to the specified set of chemical compounds, or there is some compound that is missing in the determined set of chemical compounds as compared to the specified set of chemical compounds, or the composition of the chemical compounds in the determined set of chemical compounds does not match with the composition of the chemical compounds in the specified set of chemical compounds.

In an embodiment, if the set of spectrum characteristics matches the specified set of spectrum characteristics, then the control may be transferred to 312. Otherwise, the control may be transferred to 314.

At 312, a decode signals operation is executed. In the decode signals operation, the computer system 202 is configured to decode the received LiFi communication signals based on the determination that the set of spectrum characteristics of the received LiFi communication signals matches the specified set of spectrum characteristics. The set of spectrum characteristics of the received LiFi communication signals matches the specified set of spectrum characteristics when the calculated difference value is less than the threshold difference value. The set of spectrum characteristics of the received LiFi communication signals matching with the specified set of spectrum characteristics suggests that the set of chemical compounds present at the sender side 204 as determined from the received LiFi communication signals is same as the specified set of chemical compounds. In various embodiments of the disclosure, in the decode signals operation, the computer system 202 is configured to decode the received LiFi communication signals based on the determination that the set of determined set of chemical compounds matches the specified set of chemical compounds. In the decode signals operation, the LiFi communication signals that have the set of spectrum characteristics matching the specified set of spectrum characteristics, are decoded. This is a key feature for enhancing security of data using the LiFi communication signals as there are thousands of materials and possible combinations of the materials which can be used for generating a desired spectrum of the LiFi communication signals, and providing the same spectrum is difficult unless the materials used for generating the spectrum are known. There are billions of combinations to try to get the exact combination of chemical compounds for generating the specified spectrum characteristics, and providing the materials in the spectrum is expensive and time consuming.

At 314, a restrict signals decode operation is executed. Notably, the decode signals operation and restrict signals decode operation are mutually exclusive and only one of the operations takes place based on an outcome of the operation at 310. That is, if the set of spectrum characteristics of the received LiFi communication signals matches the specified set of spectrum characteristics, then the decode signals operation is executed. In case the spectrum characteristics of the received LiFi communication signals differs from the specified set of spectrum characteristics, then the restrict signals decode operation is executed.

In various embodiments of the disclosure, where the set of chemical compounds is determined from the received LiFi communication signals and matched with the specified set of chemical compounds, a match exists when the set of chemical compounds determined from the analysis of the received LiFi communication signals are same as mentioned in the specified set of chemical compounds.

In the restrict signals decode operation, the LiFi communication signals that have the set of spectrum characteristics different from the specified set of spectrum characteristics, are suspected, and the LiFi communication signals are not decoded, and the output, at data output operation at 316, is not shown to the user. In various embodiments of the disclosure, for the restrict signals decode operation 314, the computer system 202 is configured to restrict the received LiFi communication signals from getting decoded. In various embodiments of the disclosure, the restricted LiFi communication signals are discarded and the data output operation at 316 is not executed.

In various embodiments of the disclosure, where the set of chemical compounds is determined from the received LiFi communication signals, and compared with the specified set of chemical compounds, a difference exists when the set of chemical compounds determined from the analysis of the received LiFi communication signals is different from the specified set of chemical compounds.

At 316, a data output operation is executed. In the data output operation 316, the computer system 202 is configured to show the data output via the UI 202A. Pertinently, the data output includes the presentation of the data contained in the received LiFi communication signals in a form that is easily understood by the user.

At 318, a notification render operation is executed. In the notification render operation 318, the computer system 202 is configured to render a notification to report the set of chemical compounds that are included at the sender side 204, as indicated from the analysis of the received LiFi communication signals. In various embodiments, the computer system 202 is configured to show the details of the chemical compounds as indicated from the analysis of the received LiFi communication signals, on a UI 202A. Notably, the details about the chemical compounds shown at the UI 202A at operation 318 are received by the computer system 202 from the receiver side module 206A.

In an embodiment, at 318 the computer system 202 is configured to render a first notification on the UI 202A based on the determination that the set of spectrum characteristics matches with the specified set of spectrum characteristics. In various embodiments, while rendering the first notification, the computer system 202 is configured to display on the UI 202A, the set of chemical compounds that are indicated from the analysis of the spectrum characteristics of the received LiFi communication signals. For example, a list of the chemical compounds in the set of chemical compounds appears on the UI 202A. In this example, the list of chemical compounds in the specified set of chemical compounds is also displayed along with the set of chemical compounds as indicated by the received LiFi communication signals. In an example, one of the above said two lists is rendered on the UI 202A. In various embodiments, the first notification also includes a flag indicating the presence of the specified set of chemical compounds in the received LiFi communication signals. For example, a column is shown on the UI 202A which marks that chemical compounds indicated in the specified set of spectrum characteristics and chemical compounds indicated in the received one or more LiFi communication signals are same.

In an alternate embodiment, the computer system 202 is configured to render a second notification on the UI 202A, based on the determination that the set of spectrum characteristics differs from the specified set of spectrum characteristics. In various embodiments, the computer system 202 while rendering the second notification, is configured to display the set of chemical compounds that are indicated from analysis of the spectrum characteristics of the received LiFi communication signals. For example, the computer system 202 may render a list of chemical compounds in the set of chemical compounds on the UI 202A. In an embodiment, the list of chemical compounds in the specified set of chemical compounds is also shown along with the set of chemical compounds as indicated by the received LiFi communication signals. In an alternate embodiment, the computer system 202 may be configured to render one of the abovesaid two lists on the UI 202A. In various embodiments, the second notification includes a flag indicating the absence of the specified set of chemical compounds in the received LiFi communication signals. For example, a column is shown on the UI 202A which marks that chemical compounds indicated in the specified set of spectrum characteristics and chemical compounds indicated in the received LiFi communication signals are different. Pertinently, the operation of reporting materials is a non-mandatory operation and is executed if one skilled in the art practicing the present disclosure desires to perform the operation of 318 for reporting materials.

In an embodiment, the user may wish to modify the spectrum characteristics for security purposes. To modify the spectrum characteristics, the user may use the computer system 202 to transmit a request for spectrum modification to the first electronic device 204A. Specifically, the computer system 202 may receive an input from the user to modify the spectrum characteristics. Based on the received input, the computer system 202 may transmit a request for the modification of the spectrum characteristics to the first electronic device 204A. The request may be made frequently after a certain time interval, or when the one practicing the present disclosure desires to modify the specified set of spectrum characteristics. The modification of specified set of spectrum characteristics may be construed as changing the key for decoding the received LiFi communication signals. In various embodiments of the disclosure, the request includes the modifications that the first electronic device 204A transmits/makes for modifying the set of spectrum characteristics associated with the one or more LiFi communication signals. For example, where the structure 204B of the first electronic device 204A includes a set of chemical compounds, the request made by the computer system 202 to the first electronic device 204A includes a modified set of spectrum characteristics. Thus, the modified set of spectrum characteristics will serve as new specified set of spectrum characteristics. Further, the first electronic device 204A is configured to modify the set of chemical compounds used in the structure 204B according to the request transmitted/made, or the first electronic device 204A is configured to use the structure 204B with the modified set of chemical compounds. In an example, where the set of chemical compounds is included in the LED source, then the first electronic device 204A is configured to modify the set of chemical compounds included in the LED source or the first electronic device 204A is configured to use a different LED source with the modified set of chemical compounds. Consequently, by modifying the set of chemical compounds in the structure 204B or the LED source of the first electronic device 204A, the spectrum characteristics of the LiFi signals generated and transmitted towards the receiver side module 206A will change. After the set of spectrum characteristics is modified based on the request, the computer system 202 is configured to receive a response to the request. The response indicates that the set of spectrum characteristics has been modified based on the request. Also, in various embodiments, the first electronic device 204A after receiving the request for spectrum modification from the computer system 202 is configured to send a response to the computer system 202 indicating that the set of spectrum characteristics will be modified and prompts a user via a UI of the first electronic device 204A for making the requisite modifications. In such case, the first electronic device 204A sends a response indicating that the set of spectrum characteristics has been modified, after the user has modified the set of spectrum characteristics according to the request transmitted by the computer system 202. Pertinently, the operation of reporting materials is a non-mandatory operation and is executed if one skilled in the art practicing the present disclosure desires to perform the operation for spectrum modification as described at above above.

FIG. 4 is a diagram 400 that illustrates an exemplary set of resultant spectrums of LiFi communication signals in the form of visible light after passing through structures including different chemical compounds or materials, in accordance with various embodiments of the disclosure. FIG. 4 is explained in conjunction with elements from FIG. 1, FIG. 2, FIG. 3A, and FIG. 3B.

With reference to FIG. 4, exemplary sets of spectrum characteristics of exemplary LiFi communication signals are shown. The exemplary sets of spectrum characteristics may be generated using an exemplary set of chemical compounds. An exemplary set of chemical compounds includes Fe₂O₃, Fe₃O₄, Fe(SCN)₂, Fe(OH)₃, FeS₂, FeS, Fe(OH)₂. Different chemical compounds provide different sets of spectrum characteristics of the exemplary LiFi communication signals. The ICP-OES technique based spectrometer device is configured to determine the set of chemical compounds through which the exemplary LiFi communication signals have passed before reaching the ICP-OES technique based spectrometer device.

As shown in FIG. 4, an exemplary set of graphs, namely, a first graph 402, a second graph 404, a third graph 406, and a fourth graph 408 are shown. The first graph 402, the second graph 404, the third graph 406, and the fourth graph 408 depict the variation of intensity of the exemplary LiFi communication signals with respect to the frequency of the exemplary LiFi communication signals. Also, Y1, Y2, Y3, … Y9 are numerical values that represent frequency values of the exemplary LiFi communication signals, and X1, X2, X3, … X8 are numerical values that represent light intensity values of the exemplary LiFi communication signals. Forexample, the first graph 402 is a set of spectrum characteristics generated by Fe₂O_{3.} For example, the second graph 404 is a set of spectrum characteristics generated by Fe₃O₄. For example, the third graph 406 is a set of spectrum characteristics generated by Fe(OH)₃. For example, the fourth graph 408 is a set of spectrum characteristics generated by FeS₂. Reiterating from above, no two different combinations of molecules can generate the same spectrum. Thus, the exemplary spectrums are also visibly distinctive as shown in FIG. 4. Also, one of ordinary skill in the art would appreciate that the set of spectrum characteristics shown in FIG. 4 are exemplary, and provided for understanding purposes only, and therefore, do not restrict or limit the disclosure in any possible manner.

FIG. 5 is a diagram 500 that illustrates an exemplary set of components of the first electronic device 204A, in accordance with various embodiments of the disclosure. FIG. 5 is explained in conjunction with elements from FIG. 1, FIG. 2, FIG. 3A, FIG. 3B, and FIG. 4.

As shown in FIG. 5, the bulb sub-assembly of the light source includes a bulb 504 embedded in a dielectric material 510. The bulb 504 may be an LED. The dielectric material 510 is configured to act as a waveguide for the RF energy transmitted by the power amplifier (PA) 508 and also acts as an electric field concentrator that focuses the energy into the bulb 504. The bulb 504 acts as the LED of the light source of the first electronic device 204A. The bulb 504 is configured to emit light in the visible light spectrum. The printed circuit board (PCB) 506 controls the electrical inputs and outputs of the bulb, as the microcontroller or the processing unit 512 that manages various functions of the bulb 504 is placed on the PCB 506. The PA 508 generates a radio frequency (RF) signal and directs the RF signal into the electric field of the bulb 504. An enclosure houses the bulb 504 embedded in the dielectric material 510, the PCB 506, and the PA 508. This enclosure 502 may be made of any suitable material such as, but not limited to, aluminum. The LiFi communication signals in the form of light rays, in various embodiments of the disclosure, may fall on the structure 204B. Notably, the set of components shown in FIG. 5 is not a complete set of components of the first electronic device 204A, and the first electronic device 204A may include further components that operationalize the features of the present disclosure.

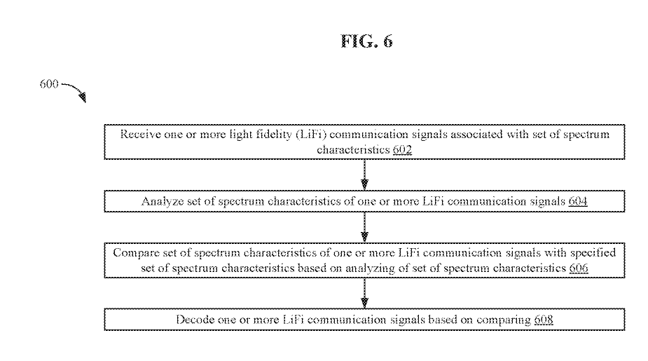

FIG. 6 is a diagram that illustrates a first flowchart 600 of a method for communication using LiFi communication signals, in accordance with various embodiments of the disclosure. FIG. 6 is explained in conjunction with elements from FIG. 1, FIG. 2, FIG. 3A, and FIG. 3B, FIG. 4 and FIG. 5. The operations of the method depicted by the first flowchart 600 may be executed by any computing system, for example, by the computer 102 of FIG. 1 or the computer system 202 of FIG. 2. The operations of the first flowchart 600 may start at 602.

At 602, one or more LiFi communication signals are received, where the one or more LiFi communication signals are associated with a set of spectrum characteristics. In various embodiments of the disclosure, the computer system 202 is configured to receive the one or more LiFi communication signals associated with the set of spectrum characteristics. The set of spectrum characteristics is indicative of a set of chemical compounds. The set of chemical compounds is associated with a light source. The light source either includes an LED placed in front of the structure 204B including the set of chemical compounds or includes an LED including the set of chemical compounds. Further, the computer system 202 is configured to receive the one or more LiFi communication signals from the light source associated with the first electronic device 204A. Here, the one or more LiFi communication signals emitted by the light source of the first electronic device 204A from the sender side 204 are received at the receiver side 206. The one or more LiFi communication signals include the data that is to be transmitted from the sender side 204 to the receiver side 206. Thus, in various embodiments, after passing through the structure 204B the one or more LiFi communication signals with absorption spectrum, are received at the receiver side 206. In various embodiments where the LED source includes some chemical compounds, the one or more LiFi communication signals with emission spectrum, are received at the receiver side 206.

At 604, the set of spectrum characteristics of the one or more LiFi communication signals is analyzed. In various embodiments of the disclosure, the computer system 202 is configured to analyze the set of spectrum characteristics of the one or more LiFi communication signals. In various embodiments of the disclosure, the analysis includes determining the intensity value of light signals at each frequency value of the visible light spectrum range.

At 606, the set of spectrum characteristics of the one or more LiFi communication signals is compared with a specified set of spectrum characteristics based on the analyzing of the set of spectrum characteristics. In various embodiments of the disclosure, the computer system 202 is configured to compare the set of spectrum characteristics of the one or more LiFi communication signals with the specified set of spectrum characteristics. Based on the comparison, the the computer system 202 is configured to determine whether the set of spectrum characteristics of the one or more LiFi communication signals matches the specified set of spectrum characteristics or not. In case the computer system 202 determines that the set of spectrum characteristics of the one or more LiFi communication signals matches with the specified set of spectrum characteristics, the computer system 202 may decode the LiFi communication signals. On the contrary, based on the comparison, in case the computer system 202 determines that the set of spectrum characteristics of the one or more LiFi communication signals differs from the specified set of spectrum characteristics, the computer system 202 may restrict the decode of the LiFi communication signals.

At 608, the one or more LiFi communication signals are decoded based on the comparing of the set of spectrum characteristics with the specified set of spectrum characteristics. In various embodiments of the disclosure, the computer system 202 is configured to decode the one or more LiFi communication signals based on the determination that the set of spectrum characteristics of the one or more LiFi communication signals matches the specified set of spectrum characteristics.

While the above operations shown in FIG. 6 are described in a particular sequence, the operations may occur in variations to the sequence in accordance with various embodiments of the present disclosure. Further, details related to various operations of FIG. 6 which are already covered in the description related to FIG. 1, FIG. 2, FIG. 3A, FIG. 3B, FIG. 4, and FIG. 5 are not discussed again in detail here for the sake of brevity.

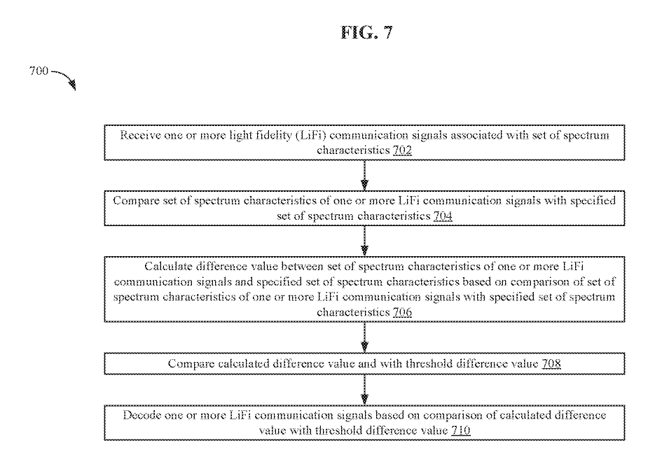

FIG. 7 is a diagram that illustrates a second flowchart 700 of a method for communication using LiFi communication signals, in accordance with various embodiments of the disclosure. FIG. 7 is explained in conjunction with elements from FIG. 1, FIG. 2, FIG. 3A, and FIG. 3B, FIG. 4, FIG. 5, and FIG. 6. The operations of the method depicted by the second flowchart 700 may be executed by any computing system, for example, by the computer 102 of FIG. 1 or the computer system 202 of FIG. 2. The operations of the second flowchart 700 may start at 702.

At 702, one or more LiFi communication signals are received, where the one or more LiFi communication signals are associated with a set of spectrum characteristics. In various embodiments of the disclosure, the computer system 202 is configured to receive the one or more LiFi communication signals associated with a set of spectrum characteristics. The spectrum characteristics are indicative of a set of chemical compounds. The set of chemical compounds is associated with a light source. The light source either includes an LED placed in front of the structure 204B including the set of chemical compounds or includes an LED including the set of chemical compounds. The one or more LiFi communication signals are received from the light source associated with the first electronic device 204A. Here, the one or more LiFi communication signals emitted by the light source of the first electronic device 204A from the sender side 204 are received at the receiver side 206. The one or more LiFi communication signals include the data that is to be transmitted from the sender side 204 to the receiver side 206. Thus, in various embodiments, after passing through the structure 204B the one or more LiFi communication signals with absorption spectrum, are received at the receiver side 206. In various embodiments where the LED source includes some chemical compounds, the one or more LiFi communication signals with emission spectrum, are received at the receiver side 206.

At 704, the set of spectrum characteristics of the one or more LiFi communication signals is compared with a specified set of spectrum characteristics. In various embodiments of the disclosure, the computer system 202 is configured to compare the set of spectrum characteristics of the one or more LiFi communication signals with the specified set of spectrum characteristics. To compare, a specified set of spectrum characteristics is already stored in the one or more databases 208. In various embodiments of the disclosure, the intensity value of the one or more LiFi communication signals at each frequency value of the visible light spectrum range is determined and compared with the corresponding intensities in the specified set of spectrum characteristics.

At 706, a difference value between the set of spectrum characteristics of the one or more LiFi communication signals and the specified set of spectrum characteristics is calculated based on the comparison of the set of spectrum characteristics of the one or more LiFi communication signals with the specified set of spectrum characteristics. In various embodiments of the disclosure, the computer system 202 is configured to calculate the difference value.

At 708, the calculated difference value is compared with the threshold difference value. In various embodiments of the disclosure, the computer system 202 is configured to compare the calculated difference value with the threshold difference value. The threshold difference value suggests the maximum allowed deviation of the spectrum pattern of the one or more LiFi communication signals from the specified spectrum pattern. Thus, in case the calculated difference value is less than the threshold difference value stored in the one or more databases 208 associated with the computer system 202, then the computer system 202 determines that the set of spectrum characteristics of the one or more LiFi communication signals matches the specified set of spectrum characteristics and the one or more received LiFi communication signals are decoded. On the contrary, in case the calculated difference value is greater than the threshold difference value stored in the one or more databases 208 associated with the computer system 202, then the computer system 202 determines that the set of spectrum characteristics of the one or more LiFi communication signals differs from the specified set of spectrum characteristics. In such case, the computer system 202 restricts the decode of the one or more LiFi communication signals.

At 710, the one or more LiFi communication signals are decoded based on the comparison of the calculated difference value with the threshold difference value. In various embodiments of the disclosure, the computer system 202 is configured to decode the one or more LiFi communication signals, based on the determination that the set of spectrum characteristics of the one or more LiFi communication signals matches the specified set of spectrum characteristics.

While the above operations shown in FIG. 7 are described in a particular sequence, the operations may occur in variations to the sequence in accordance with various embodiments of the present disclosure. Further, details related to various operations of FIG. 7 which are already covered in the description related to FIG. 1, FIG. 2, FIG. 3A, FIG. 3B, FIG. 4, FIG. 5, and FIG. 6, are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable one of ordinary skill in the art to understand the embodiments disclosed herein.

What is claimed is:

1. A computer-implemented method, comprising:
receiving, by a computer, one or more light fidelity (LiFi) communication signals associated with a set of spectrum characteristics, wherein the set of spectrum characteristics is indicative of a set of chemical compounds associated with a light source, and wherein the one or more LiFi communication signals are received from the light source associated with a first electronic device;
analyzing, by the computer, the set of spectrum characteristics of the one or more LiFi communication signals;
comparing, by the computer, the set of spectrum characteristics of the one or more LiFi communication signals with a specified set of spectrum characteristics based on the analyzing of the set of spectrum characteristics; and
decoding, by the computer, the one or more LiFi communication signals based on the comparing.

2. The computer-implemented method of claim 1, further comprising:
determining, by the computer, the set of spectrum characteristics matches the specified set of spectrum characteristics based on the comparing; and
decoding, by the computer, the one or more LiFi communication signals based on the determination that the set of spectrum characteristics matches the specified set of spectrum characteristics.

3. The computer-implemented method of claim 2, further comprising:
rendering, by the computer, a notification on a user interface (UI) based on the determination that the set of spectrum characteristics matches with the specified set of spectrum characteristics.

4. The computer-implemented method of claim 1, further comprising:
determining, by the computer, the set of spectrum characteristics differs from the specified set of spectrum characteristics based on the comparing; and
restricting, by the computer, the decoding of the one or more LiFi communication signals based on the determination that the set of spectrum characteristics differs from the specified set of spectrum characteristics.

5. The computer-implemented method of claim 4, further comprising:
rendering, by the computer, a notification on a user interface (UI) based on the determination that the set of spectrum characteristics differs from the specified set of spectrum characteristics.

6. The computer-implemented method of claim 1, wherein
the light source comprises a structure, and
the structure of the light source comprises the set of chemical compounds.

7. The computer-implemented method of claim 1, wherein the light source comprises the set of chemical compounds.

8. The computer-implemented method of claim 1, further comprising:
transmitting, by the computer, a request for modifying the set of spectrum characteristics, wherein the request is transmitted to the first electronic device; and
receiving, by the computer, a response associated with the modified set of spectrum characteristics based on the transmitted request, wherein the response is received from the first electronic device.

9. A computer system, comprising:
a processor set;
one or more computer-readable storage media; and
program instructions stored on the one or more computer-readable storage media, the program instructions executable by the processor set to cause the processor set to:
receive one or more light fidelity (LiFi) communication signals associated with a set of spectrum characteristics, wherein the set of spectrum characteristics is indicative of a set of chemical compounds associated with a light source, and wherein the one or more LiFi communication signals are received from the light source associated with a first electronic device;
compare the set of spectrum characteristics of the one or more LiFi communication signals with a specified set of spectrum characteristics;
calculate a difference value between the set of spectrum characteristics of the one or more LiFi communication signals and the specified set of spectrum characteristics based on the comparison of the set of spectrum characteristics of the one or more LiFi communication signals with the specified set of spectrum characteristics;
compare the calculated difference value with a threshold difference value; and
decode the one or more LiFi communication signals based on the comparison of the calculated difference value with the threshold difference value.

10. The computer system of claim 9, wherein the program instructions further cause the processor set to:
determine, the set of spectrum characteristics matches the specified set of spectrum characteristics based on the comparison of the calculated difference value with the threshold difference value; and
decode the one or more LiFi communication signals based on the determination that the set of spectrum characteristics matches the specified set of spectrum characteristics.

11. The computer system of claim 10, wherein the program instructions further cause the processor set to:
render a notification on a user interface (UI) based on the determination that the set of spectrum characteristics matches with the specified set of spectrum characteristics.

12. The computer system of claim 9, wherein the program instructions further cause the processor set to:
determine, the set of spectrum characteristics differs from the specified set of spectrum characteristics based on the comparison of the calculated difference value with the threshold difference value; and
restrict the decode of the one or more LiFi communication signals based on the determination that the set of spectrum characteristics differs from the specified set of spectrum characteristics.

13. The computer system of claim 12, wherein the program instructions further cause the processor set to:
render a notification on a user interface (UI) based on the determination that the set of spectrum characteristics differs from the specified set of spectrum characteristics.

14. The computer system of claim 9, wherein the program instructions further cause the processor set to:
transmit a request for modification of the set of spectrum characteristics to the first electronic device, wherein the request is transmitted to the first electronic device; and
receive a response associated with the modified set of spectrum characteristics based on the transmitted request, wherein the response is received from the first electronic device.

15. A computer program product for communication using one or more light fidelity (LiFi) communication signals, the computer program product comprising:
one or more computer-readable storage media; and
program instructions stored on the one or more computer-readable storage media to perform operations comprising:
receiving the one or more LiFi communication signals associated with a set of spectrum characteristics wherein the set of spectrum characteristics is indicative of a set of chemical compounds associated with a light source, and wherein the one or more LiFi communication signals are received from the light source associated with a first electronic device;
analyzing the set of spectrum characteristics of the one or more LiFi communication signals;
comparing the set of spectrum characteristics of the one or more LiFi communication signals with a specified set of spectrum characteristics based on the analyzing of the set of spectrum characteristics; and
decoding the one or more LiFi communication signals based on the comparing.

16. The computer program product of claim 15, wherein the program instructions stored on the one or more computer-readable storage media perform the operations further comprising:
determining the set of spectrum characteristics matches the specified set of spectrum characteristics based on the comparing; and
decoding the one or more LiFi communication signals based on the determination that the set of spectrum characteristics matches the specified set of spectrum characteristics.

17. The computer program product of claim 16, wherein the program instructions stored on the one or more computer-readable storage media perform the operations further comprising:
rendering a notification on a user interface (UI) based on the determination that the set of spectrum characteristics matches with the specified set of spectrum characteristics.

18. The computer program product of claim 15, wherein the program instructions stored on the one or more computer-readable storage media perform the operations further comprising:
determining, the set of spectrum characteristics differs from the specified set of spectrum characteristics based on the comparing; and
restricting the decoding of the one or more LiFi communication signals based on the determination that the set of spectrum characteristics differs from the specified set of spectrum characteristics.

19. The computer program product of claim 18, wherein the program instructions stored on the one or more computer-readable storage media perform the operations further comprising:
rendering a notification on a user interface (UI) based on the determination that the set of spectrum characteristics differs from the specified set of spectrum characteristics.

20. The computer program product of claim 15, wherein the program instructions stored on the one or more computer-readable storage media perform the operations further comprising:
transmitting a request for modifying the set of spectrum characteristics, wherein the request is transmitted to the first electronic device; and
receiving a response associated with the modified set of spectrum characteristics based on the transmitted request, wherein the response is received from the first electronic device.
